(19) United States
(12) Patent Application Publication
(10) Pub. No.: US 2017/0288810 A1
(43) Pub. Date: Oct. 5, 2017

(54) TIMING-ERROR DETECTION FOR CONTINUOUS-PHASE MODULATED SIGNALS

(71) Applicant: QUALCOMM Incorporated, San Diego, CA (US)

(72) Inventors: Eunmo Kang, San Diego, CA (US); Rajapaksa Senaratne, San Diego, CA (US); Koorosh Akhavan, San Diego, CA (US)

(21) Appl. No.: 15/247,789

(22) Filed: Aug. 25, 2016

Related U.S. Application Data
(60) Provisional application No. 62/314,878, filed on Mar. 29, 2016.

(51) Int. Cl. H04L 1/00

(52) U.S. Cl. CPC H04L 1/0045; H04L 1/0023; H04W 88/02

(57) ABSTRACT

In an embodiment, a receiver detects a timing error between a transmitter clock at a transmitter and a receiver clock at a receiver associated with an exchange of CPM signals. The receiver phase aligns input samples of a candidate received signal over a time window based on a rotating signal corresponding to a phase progression of the candidate received signal. The receiver generates first and second partial sums of the phase-aligned input samples that are accumulations of phase-aligned input samples corresponding to modulation symbols that contribute positive and negative phases, respectively, to the phase progression. The receiver determines a phase difference between the first and second partial sums, and generates a timing-error metric that is indicative of a timing error between the transmitter clock and the receiver clock based at least in part upon the determined phase difference.

### CROSS-REFERENCE TO RELATED APPLICATION

The present application for patent claims the benefit of U.S. Provisional Application No. 62/314,878, entitled “TIMING-ERROR DETECTION ALGORITHM FOR CONTINUOUS-PHASE MODULATED SIGNALS”, filed Mar. 29, 2016, which is by the same inventors as the subject application, assigned to the assignee hereof and hereby expressly incorporated by reference herein in its entirety.

### BACKGROUND

### 1. Field of the Disclosure

Embodiments relate to timing-error detection for continuous-phase modulated (CPM) signals.

### 2. Description of the Related Art

In a wireless communication system, a transmitter first digitally processes traffic/packet data to obtain coded data. The transmitter then modulates a carrier signal with the coded data to obtain a modulated signal that is more suitable for transmission via a wireless channel. A receiver then receives and processes the modulated signal by sampling each symbol contained therein to reconstruct the traffic/packet data.

With perfectly synchronized transmitter and receiver clocks, each symbol of a modulated signal corresponds to a fixed number of samples. With a faster receiver clock, the fixed number of samples occupies less time. This discrepancy causes the receiver to sample the successive symbols increasingly earlier than the respective optimal sampling times as time progresses. Conversely, with a slower receiver clock, this sampling happens progressively later than the optimal sampling times. If remained unchecked, this drift of symbol-sampling time due to receiver clock errors results in performance degradation, especially when receiving long packets. Transmitter clock errors cause a similar symbol sampling-time drift but in the reverse direction. Timing-error detection can help detect this clock drift and certain corrective measures can be taken to mitigate the associated performance losses.

Signals may be modulated using a number of different signaling schemes, such as continuous phase modulation (CPM). With CPM signaling schemes, the phase of the carrier signal is modulated by the coded data in a continuous rather than abrupt manner. As a result, CPM signaling schemes have several desirable characteristics such as (1) a constant envelope for the modulated signal, which allows the signal to be transmitted using an efficient power amplifier, and (2) a compact spectrum for the modulated signal, which enables efficient utilization of the available frequency spectrum.

CPM signaling schemes, such as Offset quadrature phase-shift keying (OQPSK) and minimum-shift keying (MSK) (including its variants, Gaussian MSK or GMSK), are used in several wireless communication technologies, for example, OQPSK in IEEE 802.15.4 technology and GMSK in IEEE 802.15.1 technology. OQPSK is a variant of phase-shift keying modulation that uses four different values of the phase. OQPSK alternately modulates I/Q components based on the input bits, but transmits the symbols after offsetting those two components by half the symbol period. MSK is a form of continuous phase frequency-shift keying that modulates two frequencies based on the input bits, and the specific choice of frequencies makes MSK similar to OQPSK with half-sine pulse shaping.

CPM signaling schemes such as OQPSK and MSK typically employ coding and spreading techniques to support sensitivities on par with the noise level. Therefore, the state-of-the-art receivers that operate close to the theoretical limits of such technologies require symbol-timing error correction algorithms as robust as their signal-detection algorithms. Traditional timing-error detectors require early, late, and on-time samples of a matched filter output to detect timing errors while signal detection requires only the on-time sample. Accordingly, a traditional timing-error detector has three times the hardware complexity and power consumption relative to a corresponding signal detector. This overhead is significant when matched filters are long, which can occur in systems employing coding or spreading (e.g., Code Division Multiple Access (CDMA)-based systems).

### SUMMARY

An embodiment of the disclosure is directed to a method of detecting a timing error between a transmitter clock at a transmitter and a receiver clock at a receiver associated with an exchange of continuous-phase modulated (CPM) signals, including phase aligning input samples of a candidate received signal over a time window based on a rotating signal corresponding to a phase progression of the candidate received signal, generating a first partial sum of the phase-aligned input samples that is an accumulation of phase-aligned input samples corresponding to modulation symbols that contribute positive phase to the phase progression, generating a second partial sum of the phase-aligned input samples that is an accumulation of phase-aligned input samples corresponding to modulation symbols that contribute negative phase to the phase progression, determining a phase difference between the first and second partial sums and generating a timing-error metric that is indicative of a timing error between the transmitter clock and the receiver clock based at least in part upon the determined phase difference.

Another embodiment of the disclosure is directed to a receiver configured to detect a timing error between a transmitter clock at a transmitter and a receiver clock at a receiver associated with an exchange of CPM signals. The receiver includes a matched filter and a timing-error detector configured to phase align input samples of a candidate received signal over a time window based on a rotating signal corresponding to a phase progression of the candidate received signal, generate a first partial sum of the phase-aligned input samples that is an accumulation of phase-aligned input samples corresponding to modulation symbols that contribute positive phase to the phase progression, generate a second partial sum of the phase-aligned input samples that is an accumulation of phase-aligned input samples corresponding to modulation symbols that contribute negative phase to the phase progression, determine a phase difference between the first and second partial sums, and generate a timing-error metric that is indicative of a timing error between the transmitter clock and the receiver clock based at least in part upon the determined phase difference.

Another embodiment of the disclosure is directed to a receiver configured to detect a timing error between a transmitter clock at a transmitter and a receiver clock at a receiver associated with an exchange of CPM signals. The receiver includes means for phase aligning input samples of a candidate received signal over a time window based on a rotating signal corresponding to a phase progression of the candidate received signal, means for generating a first partial sum of the phase-aligned input samples that is an accumulation of phase-aligned input samples corresponding to modulation symbols that contribute positive phase to the phase progression, means for generating a second partial sum of the phase-aligned input samples that is an accumulation of phase-aligned input samples corresponding to modulation symbols that contribute negative phase to the phase progression, means for determining a phase difference between the first and second partial sums and means for generating a timing-error metric that is indicative of a timing error between the transmitter clock and the receiver clock based at least in part upon the determined phase difference.

### BRIEF DESCRIPTION OF THE DRAWINGS

A more complete appreciation of embodiments of the disclosure will be readily obtained as the same becomes better understood by reference to the following detailed description when considered in connection with the accompanying drawings, which are presented solely for illustration and not limitation of the disclosure, and in which:

FIG. 1 illustrates a communications system including wireless communications devices.

FIG. 2 illustrates an on-time sampling plot, an early sampling plot, and a late sampling plot of phase progression due to codeword zero for a CPM signal that is transmitted in accordance with IEEE 802.15.4 OQPSK PHY.

FIG. 3 illustrates an example implementation of a matched filter array.

FIG. 4 illustrates a communications system including wireless communications devices in accordance with an embodiment of the disclosure.

FIG. 5 illustrates an example implementation of a matched filter in accordance with an embodiment of the disclosure.

FIG. 6 illustrates a process of generating a timing-error metric at a receiver in accordance with an embodiment of the disclosure.

FIG. 7 illustrates a matched filter and a timing-error detector in accordance with an embodiment of the disclosure.

FIG. 8 illustrates a communications device that includes structural components in accordance with an embodiment of the disclosure.

### DETAILED DESCRIPTION

Aspects of the disclosure are disclosed in the following description and related drawings directed to specific embodiments of the disclosure. Alternate embodiments may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the disclosure” does not require that all embodiments of the disclosure include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter.

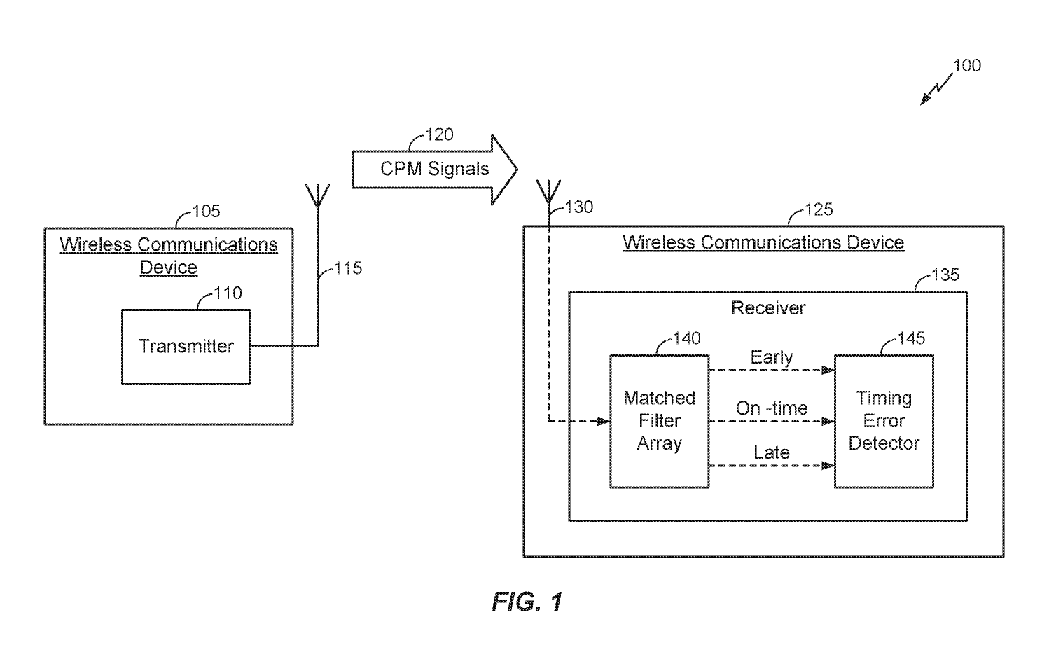

FIG. 1 illustrates a communications system 100 including wireless communications devices 105 and 125. The wireless communications device 105 includes a transmitter 110 that is coupled to an antenna 115 through which continuous-phase modulation (CPM) signals 120 are wirelessly transmitted to the wireless communications device 125. The CPM signals 120 transmitted by the wireless communications device 105 arrive at antenna 130 of the wireless communications device 125 and are passed to a matched filter array 140 of a receiver 135. The matched filter array 140 includes three matched filters that are configured to output, for each CPM signal 120, early, on-time, and late samples, respectively, of the most likely received (or input) candidate signal corresponding to the received CPM signal 120 (e.g., which may be determined via a maximum-likelihood criterion). The early, on-time, and late samples are passed to a timing-error detector 145 of the receiver 135, which evaluates whether there is a timing error between a transmitter clock at the wireless communications device 105 and a receiver clock at the wireless communications device 125.

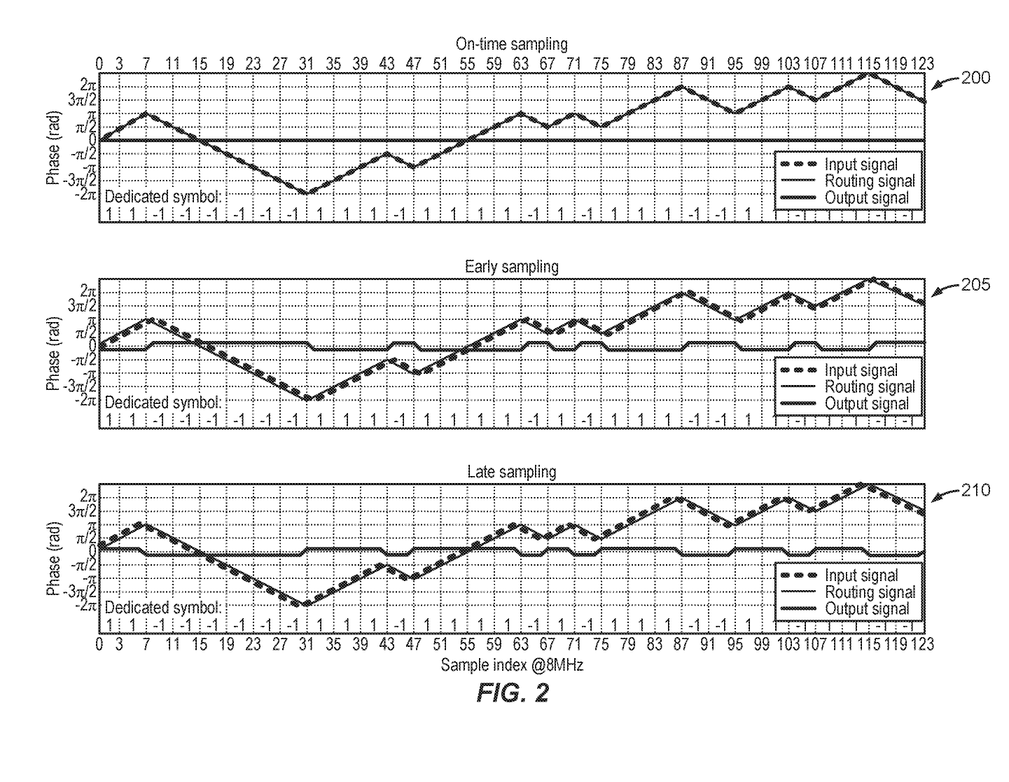

As is known in the art, IEEE 802.15.4 OQPSK PHY employs OQPSK modulation and half-sine pulse shaping. A signal transmitted in accordance with IEEE 802.15.4 OQPSK PHY has a constant envelope and a phase progression of MSK modulation, where MSK symbol +1 results in positive linear phase progression and MSK symbol −1 results in negative linear phase progression, respectively. With this in mind, FIG. 2 illustrates an on-time sampling plot 200, an early sampling plot 205, and a late sampling plot 210 of phase progression due to codeword zero for a CPM signal that is transmitted in accordance with IEEE 802.15.4 OQPSK PHY.

A matched filter (e.g., such as the on-time, early, and/or late matched filter in the matched filter array 140 of FIG. 1) designed for such a constant envelope signal, such as the IEEE 802.15.4 OQPSK PHY signal being sampled in plots 200 through 210 of FIG. 2, phase aligns and adds all samples of the received signal, where the phase alignment can be interpreted as rotation of the phase of all input samples by a “rotating signal” that has the same phase progression as the candidate received signal.

Referring to FIG. 2, the on-time sampling plot 200 shows the input (e.g., the received CPM signal or candidate received signal), rotating, and output signals when the input signal is sampled on time (i.e., when the input and rotating signals are time aligned). Because the rotating signal perfectly removes the phase of each sample of the input signal, the output signal after phase alignment has a constant phase (e.g., zero because zero initial phase is assumed in this illustration).

Referring to FIG. 2, early sampling plot 205 shows the input, rotating, and output signals when the input signal is sampled early (e.g., when the rotating signal leads the input signal in time). The phase removal results in negative residual phase for samples corresponding to MSK symbol +1 and positive residual phase for those corresponding to MSK symbol −1. The late sampling plot 210 of FIG. 2 shows the input, rotating, and output signals when the input signal is sampled late (e.g., when the rotating signal lags the input signal in time). In this scenario, the residual phases have the opposite signs of phases in the early-sampling scenario. As will be appreciated from a review of FIG. 2, the early sampling plot 205 and the late sampling plot 210 of FIG. 2 show how the symbol-timing errors differently affect the residual phase in the output samples corresponding to MSK symbols +1 and −1. In other words, the output signal is indicative of the timing error between the input signal and the rotating signal, with the output signal being set to a constant phase of zero in the on-time sampling plot 200 because these two signals are aligned perfectly in time, and with the output signal undergoing phase changes that track to the changing phase progressions of the input signal in the early sampling plot 205 and late sampling plot 210 because these two signals are not aligned perfectly in time.

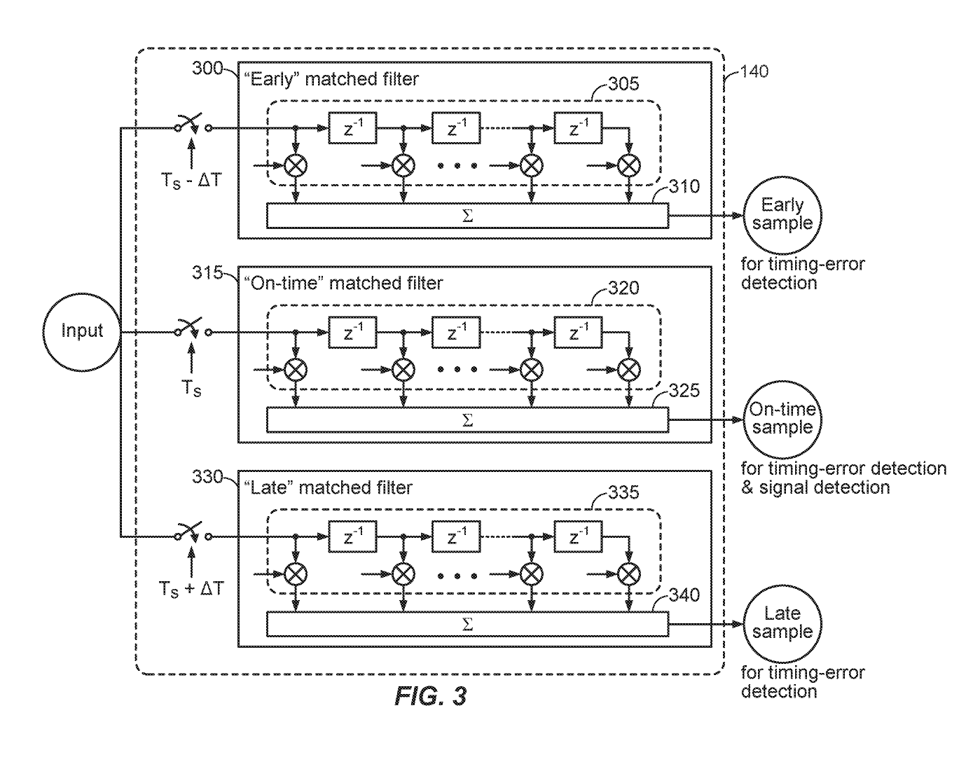

FIG. 3 illustrates an example implementation of the matched filter array 140 of FIG. 1. Referring to FIG. 3, the input signal (e.g., the CPM signal 120 of FIG. 1) described with respect to FIG. 2 above arrives at the matched filter array 140 and is passed to an early matched filter 300, an on-time matched filter 315, and a late matched filter 330. Assuming that an on-time version of the input signal corresponds to sampling time Tₛ, then an early version of the input signal corresponding to sampling time T_{S}−ΔT (e.g., wherein ΔT is a timing offset, which may correspond to a sample period of one particular sample such that T_{S}−ΔT corresponds to one sample earlier than T_{S} in an example) is passed to the early matched filter 300, the on-time version is passed to the on-time matched filter 315, and a late version of the input signal corresponding to sampling time T_{S}+ΔT is passed to the late matched filter 330. As will be appreciated from a review of FIG. 3, three sets of tapped delay lines 305, 320, and 335 and three adders 310, 325, and 340 are implemented within the early, on-time, and late matched filters 300, 315, and 330 of the matched filter array 140 to produce the early, on-time, and late samples of the input signal which are passed to the timing-error detector 145.

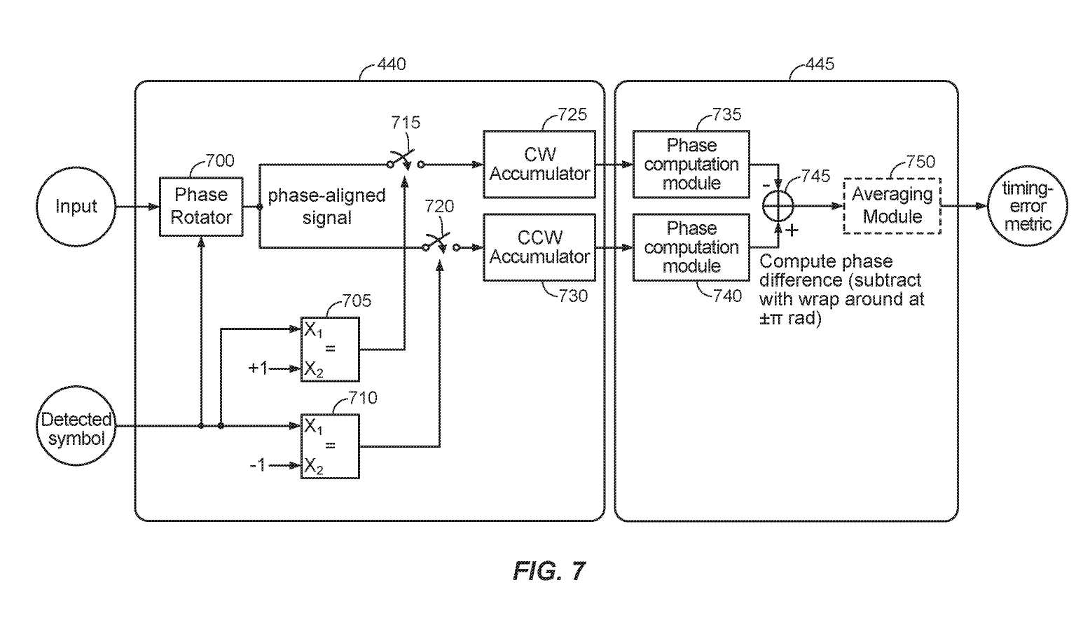

Embodiments of the disclosure relate to a matched filter implementation at a receiver which provides two partial sums of phase-aligned input samples corresponding to modulation symbols that contribute positive and negative phase to the phase progressions, respectively. While FIGS. 1-3 are described above specifically with respect to a binary modulation scheme (e.g., using symbols −1 or +1), the embodiments described below are not restricted to binary modulation schemes and instead can relate to modulation schemes with any number of symbols (e.g., 4, 8, 16, 32, 64, etc.). Certain embodiments described below, such as FIG. 7, are described with respect to a binary modulation scheme for example purposes only.

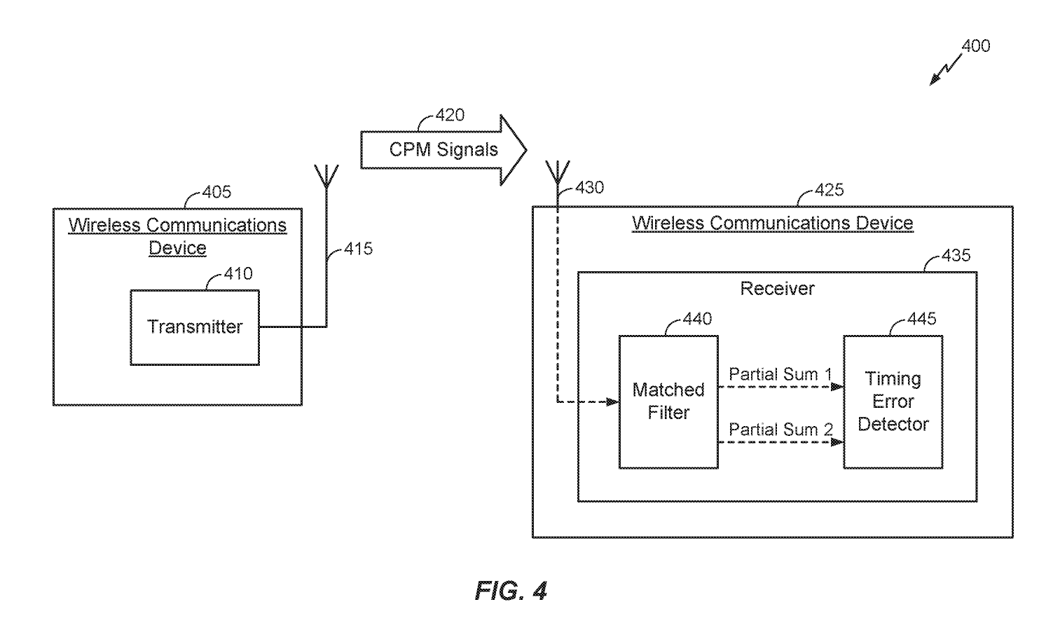

FIG. 4 illustrates a communications system 400 including wireless communications devices 405 and 425 in accordance with an embodiment of the disclosure. The wireless communications device 405 includes a transmitter 410 that is coupled to an antenna 415 through which CPM signals 420 are wirelessly transmitted to the wireless communications device 425. The CPM signals 420 transmitted by the wireless communications device 405 arrive at antenna 430 of the wireless communications device 425 and are passed to a matched filter 440 of a receiver 435. Unlike the matched filter array 140 of FIG. 1, the matched filter 440 of FIG. 4 outputs two partial sums of phase-aligned input samples to a timing error detector 445. These two partial sums include a first partial sum of input samples corresponding to modulation symbols that contribute positive phase to the phase progression of the candidate received signal (or input signal) and a second partial sum of input samples corresponding to modulation symbols that contribute negative phase to the phase progression of the candidate received signal (or input signal). As will be explained in more detail below, these partial sums can be used by the timing error detector 445 to compute a timing-error metric that indicates whether or not a timing error is present between a transmitter clock at the wireless communications device 405 and a receiver clock at the wireless communications device 425.

With respect to FIG. 4, the wireless communications device 405 and wireless communications device 425 can correspond to any devices capable of wireless communication. For example, the wireless communications device 405 may correspond to a base station with the wireless communications device 425 corresponding to a user equipment (UE) (e.g., a client device, mobile station, mobile terminal, user terminal, subscriber station, etc.), such that the CPM signals 420 correspond to forward-link signals. In another example, the wireless communications device 405 may correspond to a UE with the wireless communications device 425 corresponding to a base station, such that the CPM signals 420 correspond to reverse-link signals. In another example, the wireless communications device 405 and the wireless communications device 425 may both correspond to UEs, such that the CPM signals 420 correspond to peer-to-peer (P2P) signals.

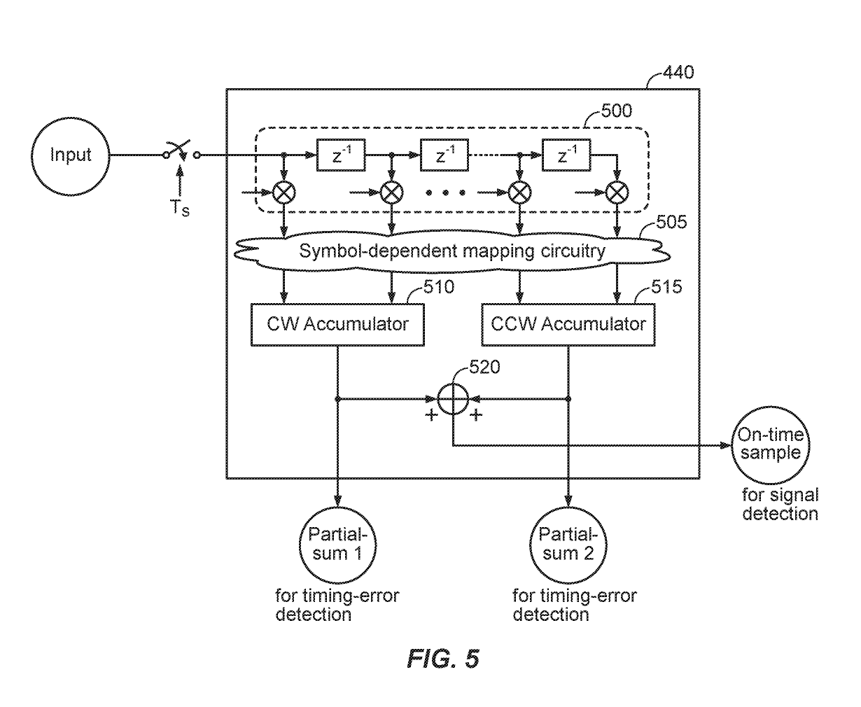

FIG. 5 illustrates an example implementation of the matched filter 440 of FIG. 4 in accordance with an embodiment of the disclosure. The matched filter 440 shares some similarity to the on-time matched filter 315 of FIG. 3 in that the signal that is input to the matched filter 440 corresponds to an on-time version of the input signal (or received candidate signal) corresponding to sampling time Tₛ, which is then processed by tapped delay line 500. However, instead of the output of the tapped delay line 500 being output to an adder for generation of an on-time sample of the input signal as in FIG. 3, the output of the tapped delay line 500 is passed to symbol-dependent mapping circuitry 505.

Referring to FIG. 5, the symbol-dependent mapping circuitry 505 processes the output of the tapped delay line 500 so as to permit a clockwise (CW) accumulator 510 and a counter-clockwise (CCW) accumulator 515 to separately add the samples corresponding to symbols contributing positive and negative phase progressions of the input signal (or received candidate signal). For example, because the MSK modulation has a linear phase progression, the residual phase is either a positive/negative constant value (e.g., as evident from the early sampling plot 205 and the late sampling plot 210 of FIG. 2), and the resulting timing-error metric becomes substantially proportional to the symbol-timing error. For example, the output signal in the early sampling plot 205 has positive phase during negative phase progression of the received candidate signal and negative phase during positive phase progression of the received candidate signal, while the output signal in the late sampling plot 210 has negative phase during negative phase progression of the received candidate signal and positive phase during positive phase progression of the received candidate signal.

With this in mind, the CW accumulator 510 calculates a sum of the samples of the output signal where the samples of the input signal corresponds to a symbol contributing positive phase progression, while the CCW accumulator 515 calculates a sum of the samples of the output signal where the samples of the input signal corresponds to a symbol contributing negative phase progression. These two sums correspond to the first and second partial sums discussed above with respect to FIG. 4. It will be appreciated that the sum of the first and second partial sums corresponds to the matched filter output (i.e., the on-time sample) for signal detection. Accordingly, in an embodiment, the matched filter 440 may include an adder 520 that is configured to separately compute the first and second partial sums while generating the on-time sample for signal detection. In other words, because the first and second partial sums are already being determined by the CW and CCW accumulators 510 and 515, separate hardware (aside from adder 520) for generation of the on-time sample for signal detection can be omitted to save costs and reduce circuit complexity. Particular configurations of the matched filter 440 and the timing-error detector 445 are described below in more detail with respect to FIG. 7.

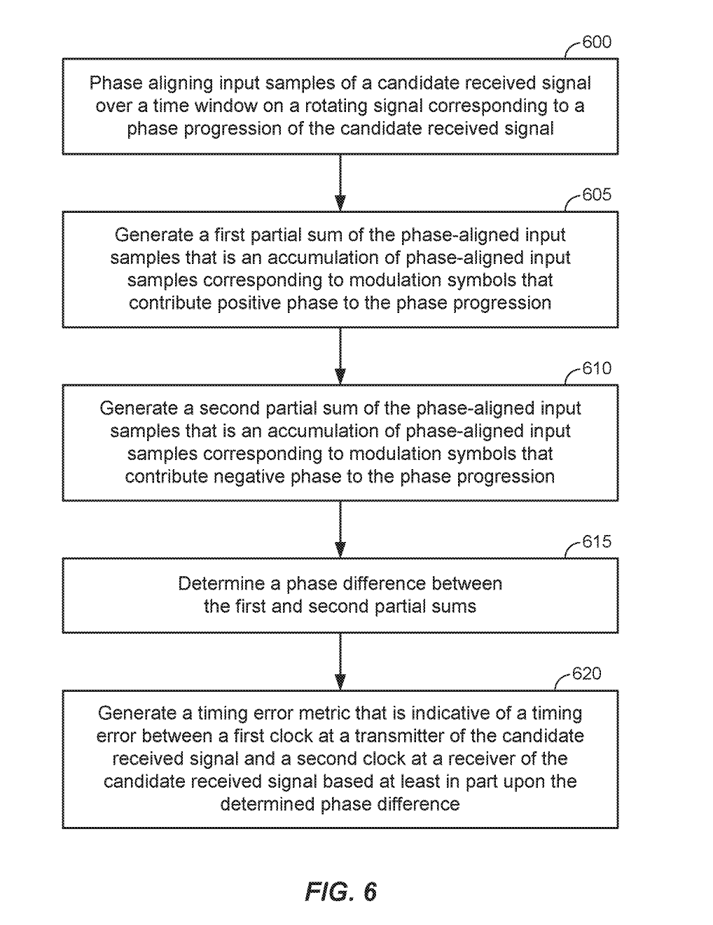

FIG. 6 illustrates a process of generating a timing-error metric at a receiver in accordance with an embodiment of the disclosure. For convenience of explanation, the process of FIG. 6 is described below as being executed by the matched filter 440 and timing-error detector 445 at the receiver 435 of FIG. 4.

Referring to FIG. 6, the matched filter 440 phase aligns input samples of a candidate received signal over a time window based on a rotating signal corresponding to a phase progression of the candidate received signal, 600. As will be discussed below in more detail, the time window (or accumulation length) is configured to include a target number of samples that is based on one or more design criteria. In an example specific to a binary modulation scheme, the phase alignment executed at 600 of FIG. 6 can use the same rotating signal that is used in any of the early, on-time, and late matched filters 300, 315 and/or 330, as is known in the art. Further, the candidate received signal upon which the phase alignment is executed at 600 of FIG. 6 can correspond to any of the CPM signals 420 that are received at the wireless communications device 425.

Referring to FIG. 6, the matched filter 440 generates a first partial sum of the phase-aligned input samples that is an accumulation of phase-aligned input samples corresponding to modulation symbols that contribute positive phase to the phase progression, 605. For example, in context with FIG. 2, the first partial sum may correspond to a sum of the output signals corresponding to modulation symbol +1.

Referring to FIG. 6, the matched filter 440 generates a second partial sum of the phase-aligned input samples that is an accumulation of phase-aligned input samples corresponding to modulation symbols that contribute negative phase to the phase progression, 610. For example, in context with FIG. 2, the second partial sum may correspond to a sum of the output signals corresponding to modulation symbol −1.

Referring to FIG. 6, the first and second partial sums are passed to the timing-error detector 445, which then determines a phase difference between the first and second partial sums, 615. The determination of 615 can be performed in any of a variety of ways. For example, the first and second partial sums, which are complex valued, can be transformed from I/Q domain into the phase domain, at which point the timing-error detector 445 subtracts a phase of the first partial sum from a phase of the second partial sum (or vice versa) to calculate the phase difference. In an alternative example, instead of transforming the first and second partial sums into the phase domain, the phase difference can be calculated via conjugate multiplication (e.g., by calculating an arctangent of a conjugate multiplication of the first and second partial sums).

Referring to FIG. 6, the timing-error detector 445 generates a timing-error metric at 620 that is indicative of a timing error between a first clock at the wireless communications device 405 and a second clock at the wireless communications device 425 based at least in part upon the determined phase difference from 615. In an example, the timing-error metric generated at 620 can simply correspond to the determined phase difference from 615. In an alternative example, the timing-error metric generated at 620 can correspond to an average of the determined phase difference from 615 and one or more previously determined phase differences (or timing-error metrics) from one or more previous executions of 600-615.

Referring to 620 of FIG. 6, in an embodiment, the timing-error metric monotonically varies with the timing error and is zero for on-time sampling. Therefore, the timing-error metric can be used as a loop-filter input into a conventional timing-error correction algorithm. Because the loop filter (not shown) averages its input, the phase difference can be used as the timing-error metric without additional averaging. Loop filters and timing-error correction algorithms are well-known in the art and are not described further for the sake of brevity.

Referring to 620 of FIG. 6, in another embodiment, depending on the accumulation length, the timing-error metric may be accurate enough to directly use its value for timing error correction. For example, where only coarse timing correction is needed, timing-error correction may be achieved through skipping (i.e., discarding) or stuffing (i.e., reusing) input samples. The timing-error metric may be compared against predetermined threshold(s) to determine when to skip/stuff samples. The accuracy improvement from averaging successive samples of the phase difference may make such implementation robust.

While FIG. 6 describes certain operations performed by the matched filter 440 and other operations performed by the timing-error detector 445, it will be appreciated that the specific structure that performs the various operations can vary in different implementations. For example, the phase difference determination of 615 and timing-error metric generation of 620 can alternatively be configured for execution by the matched filter 440 itself as opposed to the timing-error detector 445.

FIG. 7 illustrates the matched filter 440 and the timing-error detector 445 in accordance with an embodiment of the disclosure. Referring to FIG. 7, the matched filter 440 includes a phase rotator 700 that uses knowledge of the detected symbols (e.g., MSK symbols) to implement the rotating signal on the received candidate signal (or input signal). When a symbol is detected, the phase rotator 700 outputs samples of a phase-aligned signal (or output signal). As discussed above with respect to a binary modulation scheme implementation, the output signal has opposite residual phases for MSK symbols +1 and −1 in the presence of symbol timing errors based on whether the error is due to the received candidate signal being late or early.

The detected symbol is input to two comparators 705 and 710 that determine whether the detected symbol contributes a positive phase progression or a negative phase progression. In an example, for a binary symbol implementation, the first and second comparators 705 and 710 can be implemented merely by comparing the detected signal against +1 and −1, respectively. The output of each comparator 705, 710 is logic high when its inputs are equal; the output is logic low otherwise. The outputs of the first and second comparators 705 and 710 are configured to control switches 715 and 720, which in turn control whether the CW accumulator 725 or the CCW accumulator 730 receive the phase-aligned signal output by the phase rotator 700. The CW accumulator 725 and the CCW accumulator 730 track the first and second partial sums based on the received phase-aligned signal.

By controlling the control switches 715 and 720 in this manner, the detected symbols (e.g., MSK symbols) are used to demultiplex the samples of the phase-aligned signal that is output by the phase rotator 700 into two streams depending on whether each sample corresponds to a positive symbol (e.g., MSK symbol +1) or a negative symbol (e.g., MSK symbol −1). The CW accumulator 725 and CCW accumulator 730 separately accumulate the samples from the two streams. The accumulation length (or time window) is implementation dependent. In an example, the accumulation length (or time window) may be set to a multiple of a codeword length or block length of a particular wireless communications protocol (e.g., an accumulation length of 16 μs may be used for IEEE 802.15.4 OQPSK PHY because 16 μs is the duration of the codewords used in that technology). In an alternative example, if uncoded modulation or convolutional coding is used, in which case, the accumulation length can be configured to obtain a threshold number (e.g., 1, 3, 5, 13, etc.) of modulation symbols that produce positive and negative phase progressions at a particular confidence level.

Referring to FIG. 7, the CW accumulator 725 outputs the first partial sum to phase computation module 735 at the timing-error detector 445, and the CCW accumulator 730 outputs the second partial sum to phase computation module 740 at the timing-error detector 445. The phase computation modules 735 and 740 convert the first and second partial sums to the phase domain, as discussed above with respect to 615 of FIG. 6. A processing module 745 then computes the phase difference between the first and second partial sums in the phase domain (e.g., as in 615 of FIG. 6). In an example, a wrap-around in the computed phase difference may be accounted for so as to set the phase difference within a target radian range. For example, the target radian range may correspond to [−π, π], such that the phase difference is shifted to be inside the target radian range if the phase difference is higher than π or less than −π (e.g., by adding or subtracting 2π), although it will be appreciated that other target radian ranges are also possible. In an example embodiment, the phase difference output by the processing module 745 is averaged by an optional averaging module 750 with one or more previously computed phase differences for previous received candidate signals (e.g., the phase differences for the three previous successively received candidate signals, the phase differences for the ten previous successive received candidate signals, etc.), with the resultant averaged phase difference being output as a timing-error metric (e.g., as in 620 of FIG. 6). The number of successive phase differences used by the averaging module 750 to compute the phase difference average is referred to herein as an averaging length. In an example, the averaging length may depend on the requirements imposed by a selected timing-error correction algorithm (e.g., based on whether a loop-filter is used and/or whether only coarse timing correction is needed as discussed above with respect to 620 of FIG. 6, etc.) and the design requirements for a worst-case clock drift that should be detected and corrected. The averaging module 750 is optional because, as noted above, a single computed phase difference could alternatively be used as the timing-error metric.

As will be appreciated from a comparison between the matched filter array 140 as depicted in FIG. 3 and the matched filter 440 depicted in FIG. 5, the matched filter 440 requires less hardware than the matched filter array 140 because three separate matched filters are not used. Further, while the matched filter 440 depicted in FIG. 5 uses two separate accumulators, the CW and CCW accumulators 510 and 515 require hardware that is similar to the adder 325 in FIG. 3, because, when added together, the two partial sums output by the CW and CCW accumulators 510 and 510 become the on-time sample that is output by the adder 325.

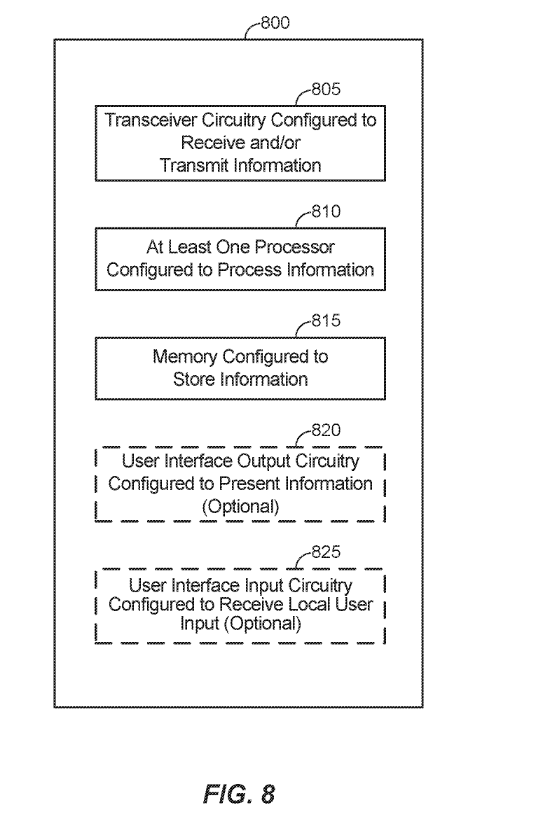

FIG. 8 illustrates a communications device 800 that includes structural components in accordance with an embodiment of the disclosure. The communications device 800 can correspond to any of the above-noted communications devices, including but not limited to the wireless communications devices 405 and/or 425 of FIG. 4.

Referring to FIG. 8, the communications device 800 includes transceiver circuitry configured to receive and/or transmit information 805. The transceiver circuitry configured to receive and/or transmit information 805 includes a wireless communications interface (e.g., Bluetooth, IEEE 802.15.4, Wi-Fi, Wi-Fi Direct, Long-Term Evolution (LTE) Direct, etc.) such as a wireless transceiver and associated hardware (e.g., an RF antenna, a MODEM, a modulator and/or demodulator, etc.). In another example, the transceiver circuitry configured to receive and/or transmit information 805 can further include a wired communications interface (e.g., a serial connection, a USB or Firewire connection, an Ethernet connection through which the Internet can be accessed, etc.). In a further example, the transceiver circuitry configured to receive and/or transmit information 805 can include an Ethernet card, in an example, that connects the communications device 800 to other communication entities via an Ethernet protocol. In a further example, the transceiver circuitry configured to receive and/or transmit information 805 can include sensory or measurement hardware by which the communications device 800 can monitor its local environment (e.g., an accelerometer, a temperature sensor, a light sensor, an antenna for monitoring local RF signals, etc.). The transceiver circuitry configured to receive and/or transmit information 805 can also include software that, when executed, permits the associated hardware of the transceiver circuitry configured to receive and/or transmit information 805 to perform its reception and/or transmission function(s). However, the transceiver circuitry configured to receive and/or transmit information 805 does not correspond to software alone, and the transceiver circuitry configured to receive and/or transmit information 805 relies at least in part upon structural hardware to achieve its functionality. Moreover, the transceiver circuitry configured to receive and/or transmit information 805 may be implicated by language other than “receive” and “transmit”, so long as the underlying function corresponds to a receive or transmit function. For an example, functions such as obtaining, acquiring, retrieving, measuring, etc., may be performed by the transceiver circuitry configured to receive and/or transmit information 805 in certain contexts as being specific types of receive functions. In another example, functions such as sending, delivering, conveying, forwarding, etc., may be performed by the transceiver circuitry configured to receive and/or transmit information 805 in certain contexts as being specific types of transmit functions. Other functions that correspond to other types of receive and/or transmit functions may also be performed by the transceiver circuitry configured to receive and/or transmit information 805.

Referring to FIG. 8, the communications device 800 further includes at least one processor configured to process information 810. Example implementations of the type of processing that can be performed by the at least one processor configured to process information 810 includes but is not limited to performing determinations, establishing connections, making selections between different information options, performing evaluations related to data, interacting with sensors coupled to the communications device 800 to perform measurement operations, converting information from one format to another (e.g., between different protocols such as .wmv to .avi, etc.), and so on. For example, the at least one processor configured to process information 810 can include a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the at least one processor configured to process information 810 may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). The at least one processor configured to process information 810 can also include software that, when executed, permits the associated hardware of the at least one processor configured to process information 810 to perform its processing function(s). However, the at least one processor configured to process information 810 does not correspond to software alone, and the at least one processor configured to process information 810 relies at least in part upon structural hardware to achieve its functionality. Moreover, the at least one processor configured to process information 810 may be implicated by language other than “processing”, so long as the underlying function corresponds to a processing function. For an example, functions such as evaluating, determining, calculating, identifying, etc., may be performed by the at least one processor configured to process information 810 in certain contexts as being specific types of processing functions. Other functions that correspond to other types of processing functions may also be performed by the at least one processor configured to process information 810.

Referring to FIG. 8, the communications device 800 further includes memory configured to store information 815. In an example, the memory configured to store information 815 can include at least a non-transitory memory and associated hardware (e.g., a memory controller, etc.). For example, the non-transitory memory included in the memory configured to store information 815 can correspond to RAM, flash memory, ROM, erasable programmable ROM (EPROM), EEPROM, registers, hard disk, a removable disk, a CD-ROM, or any other form of storage medium known in the art. The memory configured to store information 815 can also include software that, when executed, permits the associated hardware of the memory configured to store information 815 to perform its storage function(s). However, the memory configured to store information 815 does not correspond to software alone, and the memory configured to store information 815 relies at least in part upon structural hardware to achieve its functionality. Moreover, the memory configured to store information 815 may be implicated by language other than “storing”, so long as the underlying function corresponds to a storing function. For an example, functions such as caching, maintaining, etc., may be performed by the memory configured to store information 815 in certain contexts as being specific types of storing functions. Other functions that correspond to other types of storing functions may also be performed by the memory configured to store information 815.

Referring to FIG. 8, the communications device 800 further optionally includes user interface output circuitry configured to present information 820. In an example, the user interface output circuitry configured to present information 820 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communications device 800. For example, if the communications device 800 corresponds to a UE, the user interface output circuitry configured to present information 820 can include a display. In a further example, the user interface output circuitry configured to present information 820 can be omitted for certain communications devices, such as network communications devices that do not have a local user (e.g., network switches or routers, remote servers, base stations, etc.). The user interface output circuitry configured to present information 820 can also include software that, when executed, permits the associated hardware of the user interface output circuitry configured to present information 820 to perform its presentation function(s). However, the user interface output circuitry configured to present information 820 does not correspond to software alone, and the user interface output circuitry configured to present information 820 relies at least in part upon structural hardware to achieve its functionality. Moreover, the user interface output circuitry configured to present information 820 may be implicated by language other than “presenting”, so long as the underlying function corresponds to a presenting function. For an example, functions such as displaying, outputting, prompting, conveying, etc., may be performed by the user interface output circuitry configured to present information 820 in certain contexts as being specific types of presenting functions. Other functions that correspond to other types of storing functions may also be performed by the user interface output circuitry configured to present information 820.

Referring to FIG. 8, the communications device 800 further optionally includes user interface input circuitry configured to receive local user input 825. In an example, the user interface input circuitry configured to receive local user input 825 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communications device 800. For example, if the communications device 800 corresponds to a UE, the user interface input circuitry configured to receive local user input 825 can include one or more buttons, a display (if a touchscreen), etc. In a further example, the user interface input circuitry configured to receive local user input 825 can be omitted for certain communications devices, such as network communications devices that do not have a local user (e.g., network switches or routers, remote servers, base stations, etc.). The user interface input circuitry configured to receive local user input 825 can also include software that, when executed, permits the associated hardware of the user interface input circuitry configured to receive local user input 825 to perform its input reception function(s). However, the user interface input circuitry configured to receive local user input 825 does not correspond to software alone, and the user interface input circuitry configured to receive local user input 825 relies at least in part upon structural hardware to achieve its functionality. Moreover, the user interface input circuitry configured to receive local user input 825 may be implicated by language other than “receiving local user input”, so long as the underlying function corresponds to a receiving local user function. For an example, functions such as obtaining, receiving, collecting, etc., may be performed by the user interface input circuitry configured to receive local user input 825 in certain contexts as being specific types of receiving local user functions. Other functions that correspond to other types of receiving local user input functions may also be performed by the user interface input circuitry configured to receive local user input 825.

Referring to FIG. 8, while the configured structural components of 805 through 825 are shown as separate or distinct blocks in FIG. 8 that are implicitly coupled to each other via an associated communication bus (not shown expressly), it will be appreciated that the hardware and/or software by which the respective configured structural components of 805 through 825 performs their respective functionality can overlap in part. For example, any software used to facilitate the functionality of the configured structural components of 805 through 825 can be stored in the non-transitory memory associated with the memory configured to store information 815, such that the configured structural components of 805 through 825 each performs their respective functionality (i.e., in this case, software execution) based in part upon the operation of software stored by the memory configured to store information 815. Likewise, hardware that is directly associated with one of the configured structural components of 805 through 825 can be borrowed or used by other of the configured structural components of 805 through 825 from time to time. For example, the at least one processor configured to process information 810 can format data into an appropriate format before being transmitted by the transceiver circuitry configured to receive and/or transmit information 805, such that the transceiver circuitry configured to receive and/or transmit information 805 performs its functionality (i.e., in this case, transmission of data) based in part upon the operation of structural hardware associated with the at least one processor configured to process information 810.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the disclosure, it should be noted that various changes and modifications could be made herein without departing from the scope of the disclosure as defined by the appended claims. The functions, steps and/or actions of the method claims in accordance with the embodiments of the disclosure described herein need not be performed in any particular order. Furthermore, although elements of the disclosure may be described or claimed in the singular, the plural is contemplated unless limitation to the singular is explicitly stated.

What is claimed is:

1. A method of detecting a timing error between a transmitter clock at a transmitter and a receiver clock at a receiver associated with an exchange of continuous-phase modulated (CPM) signals, comprising:
phase aligning input samples of a candidate received signal over a time window based on a rotating signal corresponding to a phase progression of the candidate received signal;
generating a first partial sum of the phase-aligned input samples that is an accumulation of phase-aligned input samples corresponding to modulation symbols that contribute positive phase to the phase progression;
generating a second partial sum of the phase-aligned input samples that is an accumulation of phase-aligned input samples corresponding to modulation symbols that contribute negative phase to the phase progression;
determining a phase difference between the first and second partial sums; and
generating a timing-error metric that is indicative of a timing error between the transmitter clock and the receiver clock based at least in part upon the determined phase difference.

2. The method of claim 1, wherein the determining includes:
transforming the first and second partial sums into a phase domain, and
subtracting a first phase of one of the first and second partial sums from a second phase of the other partial sum.

3. The method of claim 1, wherein the determining includes:
applying conjugate multiplication to the first and second partial sums without transforming the first and second partial sums into a phase domain.

4. The method of claim 3, wherein the determining further comprises:
computing an arctangent based on a result of the conjugate multiplication.

5. The method of claim 1, wherein the timing-error metric is based on the determined phase difference.

6. The method of claim 5, wherein the timing-error metric corresponds to the determined phase difference.

7. The method of claim 5, wherein the timing-error metric corresponds to an average of the determined phase difference with one or more previously generated timing-error metrics.

8. The method of claim 1, further comprising:
generating an on-time sample of the candidate received signal for signal detection based on the first and second partial sums.

9. The method of claim 1,
wherein the candidate received signal is received via a spreading protocol, and
wherein the time window is a multiple of a codeword used by the spreading protocol.

10. The method of claim 1,
wherein the candidate received signal is received via a block coding protocol, and
wherein the time window is a multiple of a block length used by the block coding protocol.

11. The method of claim 1,
wherein the candidate received signal is received via uncoded modulation or convolutional coding protocol, and
wherein the time window is configured with a threshold number of modulation symbols configured to produce at least one positive phase progression of the candidate received signal and at least one negative phase progression of the candidate received signal.

12. A receiver configured to detect a timing error between a transmitter clock at a transmitter and a receiver clock at a receiver associated with an exchange of continuous-phase modulated (CPM) signals, comprising:
a matched filter and a timing-error detector configured to:
phase align input samples of a candidate received signal over a time window based on a rotating signal corresponding to a phase progression of the candidate received signal;
generate a first partial sum of the phase-aligned input samples that is an accumulation of phase-aligned input samples corresponding to modulation symbols that contribute positive phase to the phase progression;
generate a second partial sum of the phase-aligned input samples that is an accumulation of phase-aligned input samples corresponding to modulation symbols that contribute negative phase to the phase progression;
determine a phase difference between the first and second partial sums; and
generate a timing-error metric that is indicative of a timing error between the transmitter clock and the receiver clock based at least in part upon the determined phase difference.

13. The receiver of claim 12, wherein the determination of the phase difference is performed by:
transforming the first and second partial sums into a phase domain, and subtracting a first phase of one of the first and second partial sums from a second phase of the other partial sum, or
applying conjugate multiplication to the first and second partial sums without transforming the first and second partial sums into the phase domain.

14. The receiver of claim 12, wherein the timing-error metric is based on the determined phase difference.

15. The receiver of claim 14, wherein the timing-error metric corresponds to the determined phase difference.

16. The receiver of claim 14, wherein the timing-error metric corresponds to an average of the determined phase difference with one or more previously generated timing-error metrics.

17. The receiver of claim 14, wherein the matched filter is further configured to generate an on-time sample of the candidate received signal for signal detection based on the first and second partial sums.

18. The receiver of claim 14,
wherein the candidate received signal is received via a spreading protocol, and the time window is a multiple of a codeword used by the spreading protocol, or
wherein the candidate received signal is received via a block coding protocol, and the time window is a multiple of a block length used by the block coding protocol, or
wherein the candidate received signal is received via uncoded modulation or convolutional coding protocol, and the time window is configured with a threshold number of modulation symbols configured to produce at least one positive phase progression of the candidate received signal and at least one negative phase progression of the candidate received signal.

19. A receiver configured to detect a timing error between a transmitter clock at a transmitter and a receiver clock at a receiver associated with an exchange of continuous-phase modulated (CPM) signals, comprising:
means for phase aligning input samples of a candidate received signal over a time window based on a rotating signal corresponding to a phase progression of the candidate received signal;
means for generating a first partial sum of the phase-aligned input samples that is an accumulation of phase-aligned input samples corresponding to modulation symbols that contribute positive phase to the phase progression;
means for generating a second partial sum of the phase-aligned input samples that is an accumulation of phase-aligned input samples corresponding to modulation symbols that contribute negative phase to the phase progression;
means for determining a phase difference between the first and second partial sums; and
means for generating a timing-error metric that is indicative of a timing error between the transmitter clock and the receiver clock based at least in part upon the determined phase difference.

20. The receiver of claim 19, further comprising:
means for generating an on-time sample of the candidate received signal for signal detection based on the first and second partial sums.
